(19) United States
(12) Patent Application Publication
(10) Pub. No.: US 2004/0064631 A1
(43) Pub. Date: Apr. 1, 2004

(54) Pixel vault

(75) Inventors: Jakob Kishon, Pleasanton, CA (US); Mark Diel, Menlo Park, CA (US); Kathleen Davies, Fremont, CA (US); Jean-Pierre Krauer, San Jose, CA (US); David Shafer, Menlo Park, CA (US); John Johnston, Redwood City, CA (US)

Correspondence Address: BINGHAM, MCCUTCHEN LLP, THREE EMBARCADERO, SUITE 1800, SAN FRANCISCO, CA, 94111-4067, US

(73) Assignee: VIEWSONIC CORPORATION

(21) Appl. No.: 10/443,625

(22) Filed: May 22, 2003

Related U.S. Application Data
(60) Provisional application No. 60/384,911, filed on Jun. 3, 2002.

(51) Int. Cl. G06F 12/00

(52) U.S. Cl. 711/100

(57) ABSTRACT

The present invention relates to an enclosure that protects an operational data storage device (preferably a common disk data storage devices with an IDE interface) from fire, flood or other hazards. The preferred embodiment comprises an enclosure which is water resistant and heat transfer protected to preserve the disk data storage device in the event of disaster involving flood or fire. Insulation, including phase change materials, are used to maintain internal temperature during normal operation and during fire conditions, so as to meet the thermal test portion of UL 72, Class 125, one hour, and the disk data storage device temperature does not exceed 125° C. The enclosure of the preferred embodiment manages humidity to an internal RH at 80% or below.

The interface electronics are preferably external to the phase change material section of the enclosure, and are sacrificed during a fire, flood or other hazards. Electronic sensors are preferably used to sense fire or water conditions. The electronics detect a rise in temperature and manages the disk data storage device shut down before fire renders it inoperable. The connecting cable will be prevented from acting as a thermal path to the data storage devices during fire conditions by being routed though the insulating and phase change materials in a torturous path or through a cable cutting and retraction system engaged upon sensing of fire conditions.

### PRIORITY

This application claims priority on, and incorporates in full herein as if set forth in full hereat, U.S. Provisional Application No. 60/384,911, filed Jun. 3, 2002 for “Phoenix Data Safe”, which application is commonly assigned to ViewSonic Corporation, the assignee of the present invention.

### FIELD OF THE INVENTION

The preferred embodiment of this invention relates to the field of data storage device protection.

### BACKGROUND OF THE INVENTION

There has long been a need for systems and methods which can be used to protect data stored in an electronic format. As our society has more fully integrated the use of electronic data into our everyday lives, the needs for secure, reliable, convenient and affordable protection of electronic data has increased exponentially. Prior attempts to address this issue do not satisfy the full range of current needs in a way that will make the use of the security device or system practical.

For example, there are commercially available “safes” such as the FireKing Media vault, Model MV 1000, which can be used to store removable data media such as floppy discs, tapes, magnetic tape optical CDs and removable drives. This device however, requires that the user continuously make a copy of the data they wish to secure from the operating computer or other data collection device and then secure it in the safe each time the user wishes to save the data. This cumbersome process is likely to be ignored in many cases and uses. For example, where the data is manipulated on a computer, the user would be required to open the safe and retrieve the media each time the data is to be accessed in order to keep the most recent data secured.

Another data securing devices is described in Kikinis, U.S. Pat. No. 5,623,597. This device is complicated and depends on moving parts or actions which may fail in the event of any emergency. Additionally it presents the danger of a false alarm triggering the unnecessary and undesirable release of insulation material or the initiation of a forced cooling system.

### SUMMARY OF THE INVENTION

The present invention—sometimes referred to herein as a “Pixel Vault”—provides online data storage in an enclosure that protects data in the event of fire, flood, or other potentially damaging condition. The Pixel Vault of the present invention uses phase change materials, insulation, radiation shields and moisture seals to protect the data storage devices from potentially damaging environmental conditions. A warning system detects changes to the environment which could result in the complete or partial loss of data. In the preferred embodiment of the present invention, the warning system can be pre-instructed to either provide warning information to the system user and/or to trigger automatic actions to protect the stored data. Connection of the Pixel Vault to the host system can be configured to support a variety of standard electronic interfaces.

Thus, it is an object of the present invention to provide for a physical structure which will enable a usable on-line data storage device (i.e., a data storage device in ordinary use by a host computer or other device) to be protected from environmental hazards such as fire, floods, or other damaging conditions.

It is a further object of the present invention to provide a protected data storage device which will support a variety of standard electronic interfaces.

It is a further object of the present invention to provide a system for sensing imminent danger to a data storage device so as to enable the data storage device to carry out predetermined instructions with respect to any stored data.

These and other objects of the invention will be apparent to those of skill in the art from the disclosure of the present invention as set forth herein.

### BRIEF DESCRIPTION OF THE DRAWINGS

FIG. 1 is an exploded view showing the components of the Pixel Vault of the preferred embodiment of the present invention;

FIG. 2 is a diagram of the preferred embodiment of the Pixel Vault control circuitry in the preferred embodiment of the present invention;

FIG. 3 is a cross-sectional view of the assembled Pixel Vault shown along lines A-A of FIG. 1; and,

FIG. 4 is a block diagram of the sensor system of the preferred embodiment.

### DETAILED DESCRIPTION OF THE PREFERRED EMBODIMENTS

This invention is described below in reference to various embodiments and drawings. While this invention is described in terms of the best presently contemplated mode of carrying out the invention, it will be appreciated by those skilled in the art that variations and improvements may be accomplished in view of these teachings without deviating from the scope and spirit of the invention. This description is made for the purpose of illustrating the general principles of the invention and should not be taken in a limiting sense.

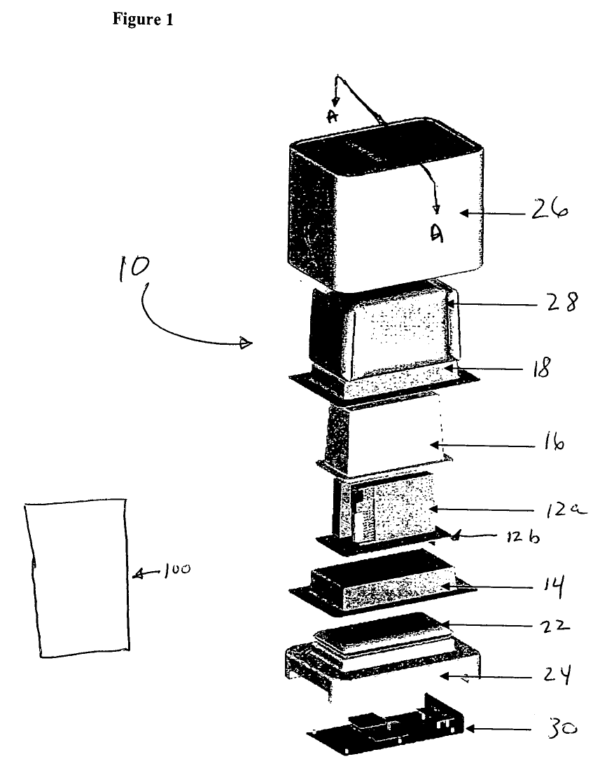

As is best illustrated in FIG. 1, the physical structure of the preferred embodiment of the Pixel Vault 10 includes a data storage device 12 (preferably, one of more computer hard disk drives 12a mounted to a drive plate 12b). The data storage device 12 is one that is actively connected to a host 100 such a personal computer or other device that utilizes the data storage capabilities of the data storage device 12. In the preferred embodiment, the data storage device 12 includes a storage device cover 16 which, together with the drive plate 12b, forms an enclosure for the data storage device 12. The enclosed data storage device 12 is encapsulated within an inner shell assembly 15, which includes an inner shell floor 14, an inner shell top 18 and a layer of phase-change bulk material 20. As discussed in more detail below, the drive cover 16 is in contact with the inner bulk material layer 20, allowing the inner bulk material layer 20 to act as a heat sink to protect the data storage unit 12.

The preferred embodiment of the present invention also includes an outer shell assembly 25. The outer shell assembly 25 is comprised of an outer shell base 24 and an outer shell cover 26. The outer shell 25 is preferably constructed from a material which is resistant to environmental stresses caused by the rigors of ordinary use, serves as an insulating material in the event of a fire and will not be damaged in the event of a flood. In the preferred embodiment, the outer shell 25 forms the casing for the secure data storage device of the present invention. Thus, in the preferred embodiment, the outer shell 25 is preferably constructed from a blow-moldable plastic typical for applications such as this as will be understood by those of skill in the art. Alternative materials known to those of skill in the art can be deployed without parting from the spirit or scope of the present invention.

An inner bulk layer 20 is positioned between the exterior of the plastic shell top 18 and the interior of the outer shell top 26. Likewise, a cushion 22 of inner bulk material is positioned between the data storage device floor 14 and the outer shell base 24. The inner bulk material is a phase change material which allows for the absorption and release of heat based upon the physical phase (e.g., solid, liquid, etc.) of the material.

As is well understood, it is necessary to protect data storage devices 12 from excessive heat. Data storage device(s) 12 are susceptible to damage if they are exposed to high heat. High heat can result from excess heat generated by the normal operation of the data storage unit 12 (what is referred to herein as “internal excess heat”) or from an external source, such as a fire (what is referred to herein as “external excess heat”). Data storage device(s) 12 typically have a maximum recommended operating temperature above which injury to the data storage unit 12 or the data stored thereon, can be expected to occur. The present invention is intended to protect the data storage unit 12 from reaching this maximum temperature damage threshold both from internal excess heat and external excess heat.

In order to insure uninterrupted functioning of typical data storage devices 12, it is necessary that the temperature of the internal data storage device 12 during normal operation should be maintained at 65° C. or cooler. Likewise, in the case of an external excess heat event, the requirements of the thermal test portion of UL 72, Tests for Fire Resistance of Record Protection Equipment, Class 125, provide that the data storage device 12 temperature should not exceed 125° C. for one hour during a fire and/or throughout the test.

The data storage device(s) 12 is attached to the inside of the inner shell cover 16 in one of many ways know to those of skill in the art which allows heat generated during normal operation of the data storage device (which could result in internal excess heat) to be conducted into the walls of the data storage device cover 16 and away from the data storage device(s) 12. In the preferred embodiment, this is achieved by attaching the data storage devices 12 directly to the device cover 16 with a thermal conductive connector (such as a screw made from a high thermal conductance metal). The device cover 16 is then in direct contact with the inner shell 18, which allows internal excess heat to pass to the inner layer bulk material 20. This inner bulk material 20 preferably has a high specific heat, meaning that it can absorb a large amount of heat energy prior to and because of undergoing a phase change.

The above structure of the preferred embodiment enables the data storage device(s) 12 to operate with out concern for damage from internal excess heat since the inner bulk material 20 has a sufficient heat absorption capacity to store the heat generated by the data storage devices 12 in normal operation while maintaining the temperature at an acceptable level in and around the area of the storage devices 12. The inner layer of bulk material 20 may also have a low thermal conductivity so as to avoid the transfer of heat away from the inner bulk layer 20. In the preferred embodiment, the inner bulk material is presently anticipated to be disodium phosphate dodecahydrate. Alternative materials known to those of skill in the art can be deployed without parting from the spirit or scope of the present invention.

The data storage device(s) 12 are protected from damaging external heat or temperatures in various ways. The containment shell 15 may be arranged to act as a radiation shield to limit radiated heat transfer in to the data storage device 12. Similarly, the exterior of the data storage device cover 16 may be coated or covered with reflective material to minimize radiated heat transfer directly into the data storage device 12. Likewise, the inner bulk material 20 may be of low thermal conductivity to limit the transfer of heat to the data storage device enclosure during a fire.

Moreover, since the inner bulk material 20 will undergo an energy absorbing phase change at a temperature below the damage threshold for the enclosed data storage device(s) 12, the energy absorption of the phase change will slow the transfer of heat to the inner shell 15 and the data storage device 12 in case of a fire. The inner bulk material 20 will also absorb excess heat generated by the data storage device 12 during periods of peak data storage device activity when the heat generated may exceed the capacity of the inner shell 15 to conduct heat out of the system and away from the data storage device(s) 12. The outer bulk material layer 28 also serves as insulation to protect the data storage device(s) 12 from extreme external temperatures. The outer bulk material layer 28 will retain its shape even if external temperatures damage the outer containment shell 25. In the preferred embodiment, the outer bulk layer is preferably comprised of gypsum. Alternative materials known to those of skill in the art can be deployed without parting from the spirit or scope of the present invention.

The assembled inner shell 15 is completely sealed against water intrusion to protect the data storage device(s) in the case of a flood or cascading water intended to put out a fire. In contrast, in the preferred embodiment of the present invention, the outer shell housing 25 is made to allow water to enter the shell so as to enable the water to interact with one or more environmental control sensors, as will be discuss more fully below.

An interface electronics card 30 is provided and connected to the data storage device 12 so as to provide an electronic data path between the host system and the data storage device 12. In the preferred embodiment, the interface electronics 30 are kept outside the layers of bulk material to minimize the heat generated during normal operation. The external location can also allow for manufacturing flexibility in the configuration of the enclosure for a variety of standard electronic interfaces.

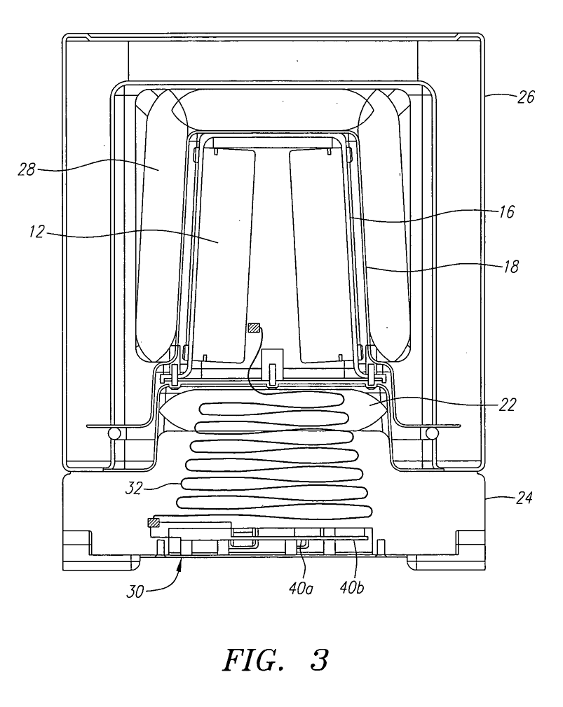

Referring to FIGS. 1 and 3, the cable 32 between the interface electronics 30 and the data storage device(s) 12 provides power and signal connections during normal operation. During a fire, the cable 32 can also provide an unwanted and potentially destructive thermal conduction path to the data storage device(s) 12. The first preferred method of limiting this unwanted heat transfer to the data storage device enclosure is to route the cable 32 though the layers of the present Pixel Vault 10 in a torturous path (as is best illustrated in FIG. 3). The so called “torturous path” of this embodiment can be any serpentine winding of the cable through the various layers in a way that will enable the cable 32 to release as much heat as possible to the elements it encounters before reaching the data storage devices 12. Thus, in the embodiment illustrated in FIG. 3, the cable 32 will be able to release heat to the outer layer of bulk material 24 and the pillow of inner bulk material 22, before any destructive heat can reach the data storage devices 12.

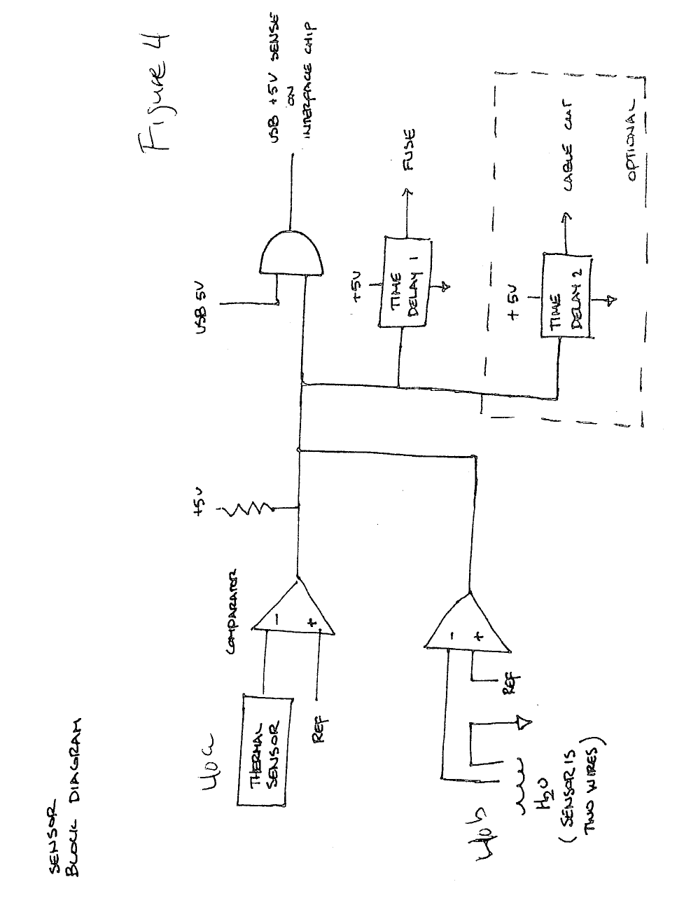

A cable cutting and retraction system (not shown) may be used as an alternative to, or in addition with, the winding of the cable 32 into a tortuous path. As presently envisioned in the preferred embodiment, the cable cutting and retraction system will be engaged upon sensing of fire or other disaster conditions. The cable cutting and retraction system will include a retractable blade or other cutting device arranged to sever the cable 32 upon receipt of a signal (from the optional circuit shown in FIG. 4) that a fire or other disaster condition exists. The cable cutting and retraction system will also be provided with a spring-loaded receptacle which, upon the cable 32 being severed, will retract the cable 32 into the core of the housing, protected by the fire resistant materials. An alternative embodiment of the cable cutting and retraction system is to have the cable 32 retract only a small distance so that the retraction device is not required to retract the entire cable 32 through the tortuous path but rather merely retracts the cable 32 a distance sufficient to move the severed end of the cable away from the fire or other disaster source.

When the insulated wires of the cable 32 passes through any structure of the present device, one or more water seals (e.g., rubber gaskets, rings, holes filled with an adhesive) will be provided so as to enable the data storage devices 12 to operate online while being encased in the pixel vault of the present invention, and still be safe from floods. The interface electronics 30, which provides an interface between the data storage device 12 and the host system 100, exists outside the outer layer of bulk material. The host system 100 can be a regular personal computer or other device that would interface with the secure data storage device 12 of the present invention.

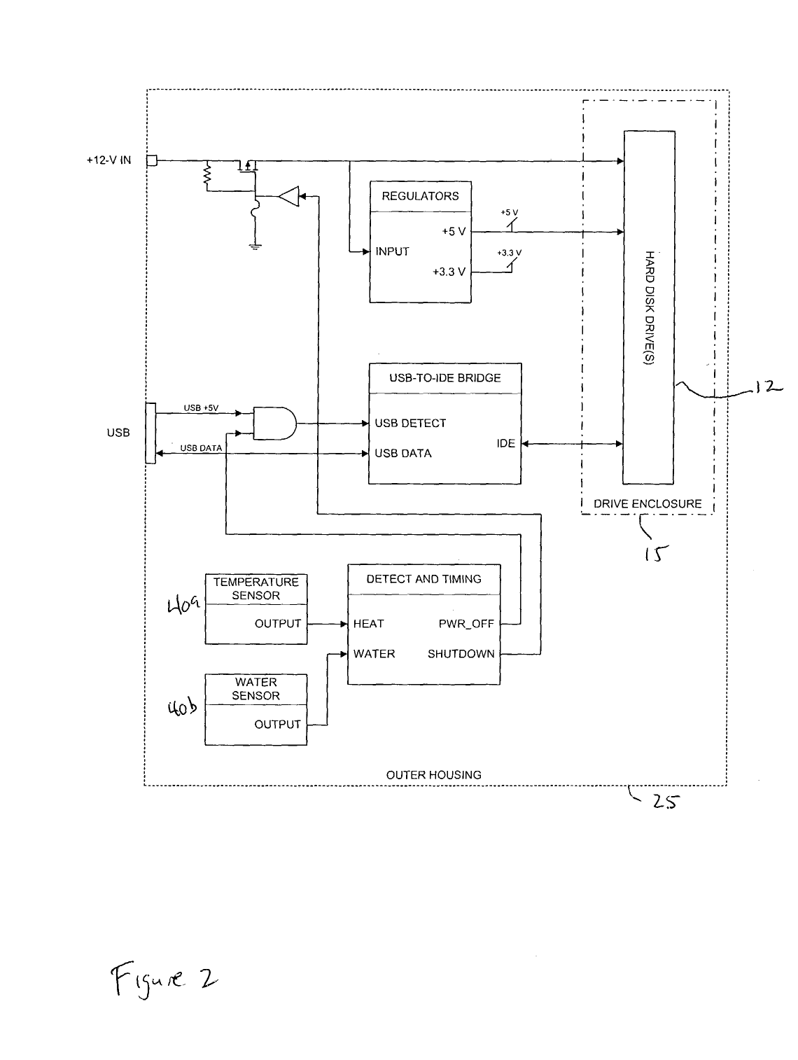

Looking to FIG. 2, when the Pixel Vault data storage device is in use, the interface electronics and firmware 30 provide an interface between the data storage device(s) 12 inside the disaster-resistant enclosure and the host computer system. The preferred embodiment shown in the attached FIG. 2 uses a USB-2.0 interface to connect to the host computer 100, and an IDE interface to connect to the internal data storage devices 12, but other choices may be made for both the host 100 and data storage device interface 30. For example, USB-1.1 or IEEE-1394 connections can provide a similar interface to the host computer, or an Ethernet port may be provided allowing attachment of the Pixel Vault 10 to a LAN rather than to an individual host computer 100.

Similarly, SCSI, Serial-ATA or other connection schemes can be used between the interface electronics 30 and the protected data storage device(s) 12. Selection of the interfaces may be tailored to the requirements of each particular need, but in general will: (i) appear to the host computer or network as a normal, on-line, external disk data storage device system; and, (ii) pass data and commands through the disaster-resistant enclosure with a minimum of compromise to the enclosure function.

The preferred embodiment meets these criteria because: (1) USB-attached storage is a common and simple method of providing external storage to a host 100, with the necessary software already present in modern operating systems; and (2) the IDE connection to the data storage device(s) in the enclosure can be made over a flex circuit, PC board, or similar cable that is easily sealed and conducts minimal heat into the enclosure.

Although the enclosure provides protection to the data storage device(s) 12 and the data they contain, in the event of a disaster (for example, fire or flood), the operation of the host computer 100 is likely to be compromised. Without some means of distinguishing normal conditions (where correct operation of the host 100 and interface 30 may be assumed) from abnormal conditions (where it is unsafe to assume that the host 100 is functioning properly and that all commands are legitimate commands), data stored on the data storage device(s) 12 may be erased or corrupted by incorrect host 100 operation caused by a malfunction resulting from the emergency. Moreover, given that the pixel vault controller and interface card 30 is located outside of the secure enclosure, it is subject to the same conditions as the host 100, and thus some form of differentiating between normal commands and those possibly influenced or caused by the disaster is highly desirable.

Therefore, the preferred embodiment of the Pixel Vault 10 of the present invention contains environmental control sensors connected to the interface electronics which can be set to automatically trigger activity to protect the stored data. The sensors 40 are preferably arranged to detect abnormal conditions and connect to circuits, as is best shown in FIG. 4, to provide an orderly shutdown or “locking down” of the data storage device(s) 12 and secure them from corruption. In the preferred embodiment, there are two sensors 40a, 40b located outside the data storage device enclosure 19 but within the Pixel Vault outer housing 25.

In the preferred embodiment in which sensors are included, the first sensor 40a is a temperature sensor, which provides a continuous reading of temperature at the interface electronics 30. This sensor triggers a locking down of the data storage device(s) 12 when the temperature reaches a high level indicative of fire. Filtering of the sensor reading may be provided by the circuitry illustrated in FIG. 4 to minimize the possibility of false triggering, since there is a large margin between temperatures encountered in normal use and those that will damage the host 100, interface electronics 30 or cabling 32.

The second sensor(s) 40b used in this embodiment of the present invention, detects water intrusion into the enclosure. The water sensors 40b are, in the preferred embodiment, likely located on or adjacent to the electronic interface board 30, at the base of the vault 10. When the water level rises to the point were the water sensors 40b are activated, a signal is sent that the moisture level is potentially dangerous. As indicated above, the outer housing 25 is made to allow water to enter, but the inner data storage device enclosure 19 prevents the water from reaching the data storage device(s) 12. Thus, presence of water in the outer housing 25 is used to disable data storage device operation, before the water reaches a level where it can cause improper operation of the controller at the interface card 30 or the host 100. In addition, if the Pixel Vault is properly located with respect to the host computer 100, this can also protect against improper host operation in the event of a flood.

In the preferred embodiment, the water sensor 40b measures the conductivity across a gap, and solid electrolytes may be included in the gap to enhance the conductivity contrast if the intruding water is very pure. However, other methods (e.g., optical, sonic or dew-point sensors) may be used to provide the same function.

The two sensors 40a, 40b used in the preferred embodiment are selected to match the main protective function of the data storage device enclosure (against fire and flood), but other applications may be envisioned. For example, if an enclosure is designed to protect against shock, an acceleration sensor could be used to prevent writing to the data storage device(s) 12 during periods of high loading. In general, the sensors are designed to prevent data corruption on the data storage device(s) 12 by the host 100 during those environmental conditions against which the data storage device(s) 12 are protected by the vault 10.

Regardless of the detection methods, once an impending disaster is sensed, the data storage device(s) 12 must be protected against the sensed condition. The following rules are used to address these issues in the preferred embodiment of the present invention. First, any operations in progress must be completed or terminated cleanly, while refusing any new operation requests from the host. Second, the data storage device(s) 12 must be put into a state where data cannot be written to the data storage device(s) in the enclosure, even assuming operation of the controller, since the controller is outside the enclosure and will be sacrificed. Third, depending on the enclosure design, operations may be needed to secure the enclosure itself.

In the preferred embodiment, the orderly shutdown is performed by removing the USB power detection to the interface IC. This simulates unplugging the data storage device from the host computer, and the USB-to-IDE interface is designed to handle this condition by completing any transaction in progress then putting the data storage device(s) into an idle state. This takes advantage of an existing feature in the controller circuitry and firmware, but other methods may be used to achieve the same result.

Once the data storage device(s) 12 are idle, they must be secured against improper operation. In the preferred embodiment, this is done by blowing a fuse to disconnect the power source. In normal operation, a fuse holds a FET switch in the ON state, and power is supplied normally to the device. However, when a disaster is sensed, after a time delay to allow the orderly shutdown, this fuse is blown, which removes all power from the data storage device(s) and the controller 30. Thus, the data storage device(s) 12 are protected against data being written incorrectly, and against improper power supply voltages being supplied, regardless of what happens to the host 100, external power supply, or interface electronics 30 during the disaster.

In those embodiments of the present invention where the cable cutting and retraction system is provided, the same sensors and circuits that control disconnection of the data storage device(s) 12 from the host 100 can also active that system if necessary.

After the disaster, the Pixel Vault 10 is not capable of normal operation. At the very least, the operation of securing the data storage device(s) 12 has taken place and prevents any external access, and likely the controller 30, cables 32, and outer housing 25 have been damaged. However, the data storage device(s) 12 are intact, and contain the stored data. To return the data to the user, the Pixel Vault 10 must be opened, and the data storage device(s) 12 removed and connected to a new controller. At this time, the data storage device(s) can be tested for data integrity and the data returned to the user. This data return can be done in many ways; in the preferred embodiment, the data storage device(s) 12 are removed from the damaged enclosure at a service facility, tested and placed into a new Pixel Vault enclosure, and the new enclosure returned to the user along with the data.

The vault 10 is completely sealed, and cannot be opened by the user. The vault of the preferred embodiment provides an enclosure for the data storage devices which has humidity management that maintains the internal RH at 80% or below. The data storage device(s) 12 of the preferred embodiment uses commonly available 3½-inch hard disk data storage devices with an IDE interface. So configured, the entire unit meets the requirements of the thermal test portion of UL 72, Tests for Fire Resistance of Record Protection Equipment, Class 125 for one hour. During a fire and/or throughout the test, the disk data storage device 12 temperature should not exceed 125° C. Heat from a fire is not the only abnormal condition against which the present invention can provide detection and protection. Other abnormal conditions for which protection is provided include submersion of the pixel vault in water of approximately 8 feet deep and the dropping of the Pixel Vault from a height of approximately 30 feet onto a concrete surface. The inner shell assembly 15 of the Pixel Vault of the present invention constructed in accordance with the preferred embodiment should be watertight so that it provided protection of the data storage device(s) 12 from exposure to water. Likewise, the design of the inner and shells, together with the bulk materials, provides the Pixel Vault with its shock resistance.

An additional data-security feature is provided as part of the Pixel Vault 10, and allows the user to set a password to protect the stored data from unauthorized access. This may be implemented in the controller circuitry or firmware, but in the preferred embodiment the password protection is provided by using data storage device(s) that implement this feature in their internal controller electronics. Pixel Vault provides a host 100 with a data storage device that allows the user to set the password, which is stored in the data storage device(s) themselves. When a password is stored, the user must supply it every time power is removed from the data storage device(s), before any future data storage device operation will be accepted or permitted. This prevents viewing the contents of the data storage device, as well as accessing the contents of the files themselves, and still protects the data even if the Pixel Vault is disassembled and the data storage device(s) connected directly to a host 100.

The preferred embodiment can contain one or two data storage device(s) 12, but other connection methods between the controller and data storage device(s) allow for more than two data storage devices. Whenever more than one data storage device is used, the controller can provide RAID (Redundant Array of Inexpensive Disks) functions. In the preferred embodiment, this takes the form of data storage device mirroring, where data written to the Pixel Vault is duplicated and stored on both data storage devices. This allows complete restoration of the data in the event of failure of one of the data storage devices, at the expense of a reduced storage capacity. With two data storage devices, the user can configure the preferred embodiment to provide maximum capacity (no mirroring) or complete redundancy (data storage devices mirrored). With other connections and more than two data storage devices, other RAID levels may be implemented, allowing for different tradeoffs between capacity and reliability against data storage device failure.

Although the foregoing description and the preferred embodiment focus on the protection of stored data in the event of disaster, the same methods may be used in applications where the security of the data is ensured by its destruction rather than its preservation. For example, detection of physical removal of the Pixel Vault 10 (e.g., by loss of connection to a LAN or unplugging from a rack) could trigger overwriting of stored sensitive data. If this operation must be completed while the Pixel Vault 10 is unplugged, an internal battery backup may be provided to allow data destruction.

While the invention has been described with respect to the illustrated embodiments in accordance therewith, it will be apparent to those skilled in the art that various modifications and improvements may be made without departing from the scope and spirit of the invention. Accordingly, it is to be understood that the invention is not to be limited by the specific illustrated aspects and embodiments.

What is claimed is:

1. A secure data storage device for use with a host unit, comprising:
at least one electronic data storage unit,
at least one interface circuit, the interface circuit being electronically connected to said data storage unit and the host unit so as to permit the data storage unit to interact with the host unit; and
at least a first enclosure, said first enclosure arranged so as to substantially encase the electronic data storage unit, said first enclosure being constructed of at least one layer of material which can undergo a phase change in order to absorb heat so as to protect the electronic data storage unit from being damaged by excessive heat.

2. A secure data storage device of claim 1 wherein the first enclosure is sealed watertight.

3. A secure data storage device of claim 1 wherein the data storage unit includes a second enclosure external to the first enclosure;
the second enclosure being constructed of a material which is resistant to fire and arranged to act as an external casing for the secure data storage device.

4. A secure data storage device of claim 1 wherein at least one sensor is electronically connected to the interface circuit, the data storage unit being arranged to execute a pre-established process within the data storage unit in response to a sensor signal.

5. A secure data storage device of claim 1 wherein the electronic data storage unit is arranged to actuate a pre-established process within the data storage device in the absence of a signal from the interface circuit.

6. A secure data storage device of claim 4 wherein the sensor is arranged to sense the presence of at least one of fire and flood conditions; and
said data storage unit is arranged to cause a shutdown of all functions of the data storage unit upon receipt of the earlier of a sensor signal and the absence of a signal from the interface circuit.

7. The secure data storage device of claim 4 wherein the pre-established process is the erasure of all data on the data storage unit.

8. A secure data storage device of claim 1 wherein an electronic communication cable is provided between the interface circuit and the data storage device, said cable being arranged so as to minimize the heat transfer through such cable to the data storage device.

9. A secure data storage device of claim 8 wherein the cable is arranged in a serpentine path through the layers of the first enclosure.

10. An apparatus for protecting an electronic data storage device which is actively connected to a host system, the apparatus comprising:
a first enclosure, said first enclosure substantially enclosing the electronic data storage device;
a second enclosure, said second enclosure being arranged to enclose the first enclosure;
a phase change layer, said phase change layer being arranged so as to protect the electronic data storage device from internal damaging heat or external damaging heat; and
means for enabling electronic signals to pass between the enclosed data storage device and the host during normal operation of the data storage device.

11. The apparatus of claim 10 wherein:
the means for enabling the passing of electronic signals comprises at least one data storage device interface circuit, said interface circuit being positioned external to said second enclosure, and at least one data cable connected between the data storage device and the interface circuit and the interface circuit and the host.

12. The apparatus of claim 11 wherein the data storage device is arranged to execute a predetermined sequence of commands upon the earlier of the absence of any signal from the interface circuit and a signal from the interface circuit of the presence of abnormal conditions.

13. A method of protecting data stored on an electronic storage device, the steps comprising:
saving data to an electronic data storage device, said electronic data storage device being enclosed in a first enclosure shell, said first enclosure shell being arranged so as to conduct heat resulting from the normal operation of the electronic data storage device away from the electronic data storage device, a phase change layer, said phase change layer being arranged so as to absorb heat produced by the electronic data storage device during normal operation of the electronic data storage device and arrange to absorb heat in the event of a fire external to the phase change layer, the phase change layer being constructed of a material from a type which undergoes a phase change at a temperature below the maximum temperature damage threshold of the electronic data storage device.

14. A method of protecting data of claim 13, wherein the steps further comprise:
locking down the electronic data storage device in response to the first to occur of an external signal of the existence of one or more abnormal conditions and the absence of any signal from an interface circuit.

15. In a data storage device, an improved enclosure to protect the electronic data storage device drives from damaging external conditions, the improvement comprising:
a first enclosure, the first enclosure being thermally connected the electronic data storage device drives so as to remove internal damaging heat from the electronic data storage drives;
a phase change layer, said phase change layer being arranged so as to act as a heat sink for any internal damaging heat not absorbed by the first enclosure, said phase change material being of a type which undergoes a phase change at a temperature below the maximum temperature damage threshold of the electronic data storage drives.

16. The improved enclosure of claim 15 wherein the first enclosure is a watertight enclosure.

17. The improved enclosure of claim 15 wherein the enclosure further comprises:
a second enclosure, said second enclosure being external to the first enclosure, a second enclosure being constructed of a material which is substantially fire resistant.

18. The improved enclosure of claim 17 wherein the first enclosure, the second enclosure and the phase change layer are arranged so as to protect the data storage drives in the event the improved enclosure is dropped.
